(19) United States
(12) Patent Application Publication
(10) Pub. No.: US 2014/0156842 A1
(43) Pub. Date: Jun. 5, 2014

(54) METHOD AND APPARATUS FOR ASSEMBLING ELEMENTS OF DATA TRANSACTIONS

(71) Applicants: Alon Bar-Lev, Ramat-Hashofet (IL); Lanir Naftaly Shacham, Ramat-Hasharon (IL); Oren Shlomo Elias, Herzeliya (IL)

(72) Inventors: Alon Bar-Lev, Ramat-Hashofet (IL); Lanir Naftaly Shacham, Ramat-Hasharon (IL); Oren Shlomo Elias, Herzeliya (IL)

(73) Assignee: CORRELSENSE LTD., Hertzlia Pituach (IL)

(21) Appl. No.: 14/234,392

(22) PCT Filed: Aug. 3, 2011
(86) PCT No.: PCT/IL2011/000628

§ 371 Date: Jan. 23, 2014

(51) Int. Cl. H04L 12/26

(52) U.S. Cl. CPC H04L 43/10
USPC 709/224

(57) ABSTRACT

A computerized method for organizing representations of transactions in a multi-node system, comprising randomly selecting by each computer of a plurality of computers a message in a repository of messages of transactions accessible to the plurality of computers, and selecting in the repository by each computer of the plurality of computers further messages belonging to the transaction the randomly selected message belongs to, and assembling the selected messages to a representation of the transaction the randomly selected message belongs to, and an apparatus for the same.

### BACKGROUND

The present disclosure generally relates to assembly of related data elements into interrelated structures, and more particularly, in some embodiments, to assembly of elements of data transactions into structures representing the data transactions.

Distributed applications such as in multi-tier or multi-node applications, web-applications or client-server applications are contemporarily in general use.

Monitoring the elements of data transactions, such as requests and responses among the nodes of a distributed system, was reported in the art as, for instance, in the following exemplary references.

U.S. Pat. No. 5,958,010 reports of systems and methods for automated monitoring and management of distributed applications, client/server databases, networks and systems across heterogeneous environment by distributed, automated monitoring agents with embedded sensing technology which is knowledgeable of application protocols, where U.S. Pat. No. 6,714,976 also report a controller for remotely coordinating the data gathering process from the various clients and servers.

U.S. Pat. No. 6,792,460 reports a monitoring system monitors the amount of time spent by specific application components, such as Java components, during execution of specific web site transactions.

U.S. Pat. No. 7,051,339 reports API for assigning a single general reference to characteristic transactional information associated with a transaction to be executed by the computer application.

U.S. Pat. No. 7,805,509 reports monitoring a selected tier in a multi-tier computing environment, the apparatus including a context agent and a dynamic tier extension, the context agent associated with the selected tier and coupled with other context agents, each of which is associated with a respective tier, the dynamic tier extension coupled with the context agent and with specific predetermined points of the selected tier, the dynamic tier extension monitoring request traffic passing through the selected tier.

US application 2011/0035493 reports a method and apparatus for associating requests and responses in a multi-tier computerized environment, comprising for each tier, detecting incoming and outgoing data flow; sending the detected data to a processing module; for each two neighboring tiers, comparing incoming data of one tier and outgoing data of the other tier; associating incoming requests of one tier to outgoing requests of the other tier.

Monitoring schemes such as exemplified above generally provide information indicating which elements, such as requests and responses of a plurality of data transactions, belong to which transaction and the relation of the elements to other elements of a transaction.

Generally, in many cases, a transaction comprises many communication-messages transferred between numerous nodes, where a large number of transactions occurring in parallel or partly in parallel or within a short period of time therebetween.

A transaction may comprise thousands of communication-messages spanning through tens of hundreds or thousands of nodes with millions or about a billion transactions occurring within an hour.

### SUMMARY

One exemplary embodiment of the disclosed subject matter is a computerized method for organizing representations of transactions in a multi-node system, comprising randomly selecting by each computer of a plurality of computers a message in a repository of messages of transactions accessible to the plurality of computers, and selecting in the repository by each computer of the plurality of computers further messages belonging to the transaction the randomly selected message belongs to, and optionally assembling the selected messages to a representation of the transaction the randomly selected message belongs to.

In some embodiments, the method further comprises assembling the selected messages to a representation of the transaction the randomly selected message belongs to.

Another exemplary embodiment of the disclosed subject matter is a system for organizing representations of transactions in a multi-node system, comprising, a plurality of computers, each computer of the plurality of computers having equivalent access to a repository of messages of transactions and configured to randomly select a message in the repository, wherein, optionally, each computer is configured for randomly selecting a different message.

In some embodiments, the apparatus is further configured for selecting in the repository by each computer of the plurality of computers further messages belonging to the transaction the randomly selected message belongs to, and for assembling the selected messages to a representation of the transaction the randomly selected message belongs to.

Yet another exemplary embodiment of the disclosed subject matter is a method for organizing elements of an entity, comprising randomly selecting by each computer of a plurality of computers an element in a repository of elements of entities equivalently accessible to the plurality of computers, selecting in the repository by each computer of the plurality of computers further elements belonging to the entity the randomly selected element belongs to.

In some embodiments, the method further comprises assembling the selected elements to a representation of the entity the randomly selected element belongs to.

For brevity and clarity and without limiting, in the present disclosure referring to a transaction implies a data transaction involving exchange of communications between two or more locations or nodes of a multi-node system, such as a client-server or a client-server-database.

In the context of the present disclosure, without limiting, elements of a transaction participating in the data exchange between nodes, such as requests and responses, are collectively referred to as communications or communication-messages, where a communication or a communication-message refers to either to a data request or a data response, without precluding any other element of a transaction such as a reception acknowledgement or a flow control signaling.

In the context of the present disclosure, a message-ID or an ID implies information indicating or relating either directly or indirectly to which transaction a communication belongs to and, optionally, to the relation of the communication to other communications of the transaction. Generally, the ID is provided or derived from a monitoring process or processes that track the communications in a multi-node system.

For brevity and clarity, referring to a message implies contents of a communication-message, or a part thereof, or a representation thereof, such as a collection or a construct of data items related to the communication-message that comprises at least the message-ID, optionally with other data such as an indication of the source node, an indication of the destination node or a time-stamp.

Thus, there is a one-to-one correspondence between a message and a respective communication, and a relation of both to a respective transaction.

In the context of the present disclosure, without limiting, referring to a microcomputer implies a low cost computer or processing apparatus of limited resources, as compared to a powerful server or a mainframe, such as a personal computer or an equivalent or a similar apparatus.

### BRIEF DESCRIPTION OF THE DRAWINGS

Some non-limiting exemplary embodiments or features of the disclosed subject matter are illustrated in the following drawings.

Identical or duplicate or equivalent or similar structures, elements, or parts that appear in one or more drawings are generally labeled with the same reference numeral, optionally with an additional letter or letters to distinguish between similar objects or variants of objects, and may not be repeatedly labeled and/or described.

Dimensions of components and features shown in the figures are chosen for convenience or clarity of presentation and are not necessarily shown to scale or true perspective. For convenience or clarity, some elements or structures are not shown or shown only partially and/or with different perspective or from different point of views.

References to previously presented elements are implied without necessarily further citing the drawing or description in which they appear.

FIG. 1 schematically illustrates a system for collecting messages respective to individual transactions in a shared repository, according to exemplary embodiments of the disclosed subject matter;

FIG. 2 schematically illustrates a system for collecting messages respective to individual transactions in duplicated repositories, according to exemplary embodiments of the disclosed subject matter;

FIG. 3 schematically illustrates a multi-node transaction system, according to exemplary embodiments of the disclosed subject matter;

FIG. 4A schematically illustrates grouping of messages as provided by monitoring process of FIG. 3, according to exemplary embodiments of the disclosed subject matter;

FIG. 4B schematically illustrates grouping of messages according to a node as provided by monitoring process of FIG. 3, according to exemplary embodiments of the disclosed subject matter;

FIG. 5A schematically illustrates a repository of parts numbers, according to exemplary embodiments of the disclosed subject matter;

FIG. 5B schematically illustrates assembly of the parts numbers of FIG. 5, according to exemplary embodiments of the disclosed subject matter;

FIG. 6 outlines operations for forming a representation of transactions in a multi-node transaction system, according to exemplary embodiments of the disclosed subject matter; and

FIG. 7 outlines operations for forming a representation of an entity from elements related thereto, according to exemplary embodiments of the disclosed subject matter.

### DETAILED DESCRIPTION

One technical problem dealt by the disclosed subject matter is collecting or grouping or assembling messages belonging to the same transaction from among messages belonging to a plurality of transactions, in a cost-effective and a sufficiently fast manner.

A cost effective manner implies using an apparatus of a marginal or insignificant cost relative to the transactions system equipment and/or operational costs. Furthermore, cost effective may also imply an operation that does not or negligibly interfere with the transaction system operation and/or the monitoring process that track communications in the transaction system.

A sufficiently fast manner implies collecting messages belonging to individual transactions along with monitoring the respective communications in the transaction system, or within a time sufficient for reviewing or analyzing or processing the transactions without losing track thereof.

It is noted that although the messages may be buffered, at least for a certain capacity or time, yet generally the messages may or are provided dynamically ‘on the fly’. Thus, a sufficiently fast manner implies, alternatively or additionally, a response time that does not miss messages and/or does not block or impede or otherwise adversely affect the monitoring process.

In the context of the present disclosure a straightforward approach such as of using costly equipment that sequentially processes the messages one by one, such as a super-computer or a top-of-the-line mainframe or a sufficiently powerful custom-made processing apparatus, would not be cost effective.

As the quantity and/or rate of the messages increase, using such costly equipment may possibly amount to reaching a technology barrier and/or a prohibitive cost.

On the other hand, a microcomputer may lack resources to collect or group the messages sufficiently fast, and may have adverse effects on the system operation such as impeding or blocking the monitoring process.

A solution approach may be a distribution of the processing load among several microcomputers, akin to a grid processing approach.

However, dispatching or dividing the messages of individual transactions separately to microcomputers amounts to the very essence of the collection or grouping operation, with a possible overload of dispatching and control.

Alternatively, letting the microcomputers to operate on the messages by identical or similar programs, deterministically each microcomputer will perform essentially the very same operation on the same messages in parallel, with an extra waste of redundant resources.

One technical solution according to the present disclosure is a plurality of microcomputers, each having equal or identical access to the messages of the transactions, and in order to avoid parallel redundant operations on the same messages of a transaction at a time, each microcomputer is configured or programmed to select an initial message of a transaction different than the messages of transactions selected by the other microcomputers. Subsequently each microcomputer collects or groups other messages that belong to the particular transaction that the initially selected message belongs to.

A microcomputer is configured to select an initial message different than the other computes by one or more mechanisms or procedures that determine, at least to a certain extent, that each microcomputer would select a different message. For example, using different formulas to generate different numbers, or using the same formula with different parameters, or any combination thereof or any other method such as a random number generator with different seeds. Accordingly, apparently or practically, each computer generates a seemingly random number according to which a message is selected.

For brevity, any mechanism that generates an at least seemingly random number, or affects or induces each microcomputer to randomly select a message, is referred to also as ‘randomly selecting’ or similar term to that effect.

Thus, it is most probable that each microcomputer will work on messages of different transactions, particularly considering the huge volume of the transactions traffic that decreases the likelihood of randomly selecting messages of the same transactions at different microcomputers.

Having a microcomputer selected or collected messages of a transaction, then another message is randomly selected by the microcomputer for selecting or collecting messages of another transaction.

Once messages of a transaction are collected or grouped, the messages are removed from the storage thereof. Optionally or alternatively, the messages are marked for deletion for a process that scans the storage and deletes the marked messages and/or for indicating other microcomputers to ignore the marked messages.

Optionally or alternatively, once a message of a transaction is randomly selected by a microcomputer, that microcomputer notifies the other microcomputers to the effect that in case another microcomputer selected and/or will select a message of the same transaction, then that another microcomputer will ignore the message and/or transaction thereof, thereby avoiding working on the same transaction again. Optionally or alternatively, only when collecting or grouping of messages of a transaction is finished or decided as finished that the other microcomputers are notified.

It is noted that essentially and practically each microcomputer operates independently of each other, optionally with a minimal or sufficiently negligible synchronization therebetween, such as when a microcomputer notifies others about a transaction that the microcomputer started to work at.

In some cases messages may remain in the storage thereof due to missing by the random selection or due to other reasons such as incoming messages. Thus, in some embodiments, an at least one additional computer, or one or of the microcomputers, runs a process that scans messages that were left over and collects and groups the remaining messages. Optionally, the process removes the collected messages from the storage thereof or marks the collected messages for deletion.

As the microcomputers each has access to all the messages, as the transactions traffic increases additional microcomputers may be added to cope with the extra processing load. And conversely, if the transactions traffic decrease microcomputers may be removed. Likewise, in order to anticipate an increase in the transaction traffic and/or to provide safe margins for intermittent load peaks, additional microcomputers may be added. Accordingly, the solution is scalable, either up-scalable or down-scalable.

Furthermore, having all the microcomputers to essentially or effectively operate according to and/or under a control of the same software or coded procedures, then the solution is generally linearly scalable according to the number of microcomputers.

A potential technical effect of the disclosed subject matter is a scalable sub-system of a multiplicity of microcomputers that groups messages of transactions, thereby proving tracing of transactions in a multi-node system.

It is noted that essentially the solution may be applied with any kind of computers or a combination or a mixture of different computers. Accordingly, unless otherwise specified, referring herein to a computer implies a microcomputer or any other computer.

It is also noted that the solution described above may be applied, rather then to transactions, to other data elements having a relation therebetween such as parts related to a product.

A general non-limiting overview of practicing the present disclosure is presented below. The overview outlines exemplary practice of embodiments of the present disclosure, providing a constructive basis for variant and/or alternative and/or divergent embodiments, some of which are subsequently described.

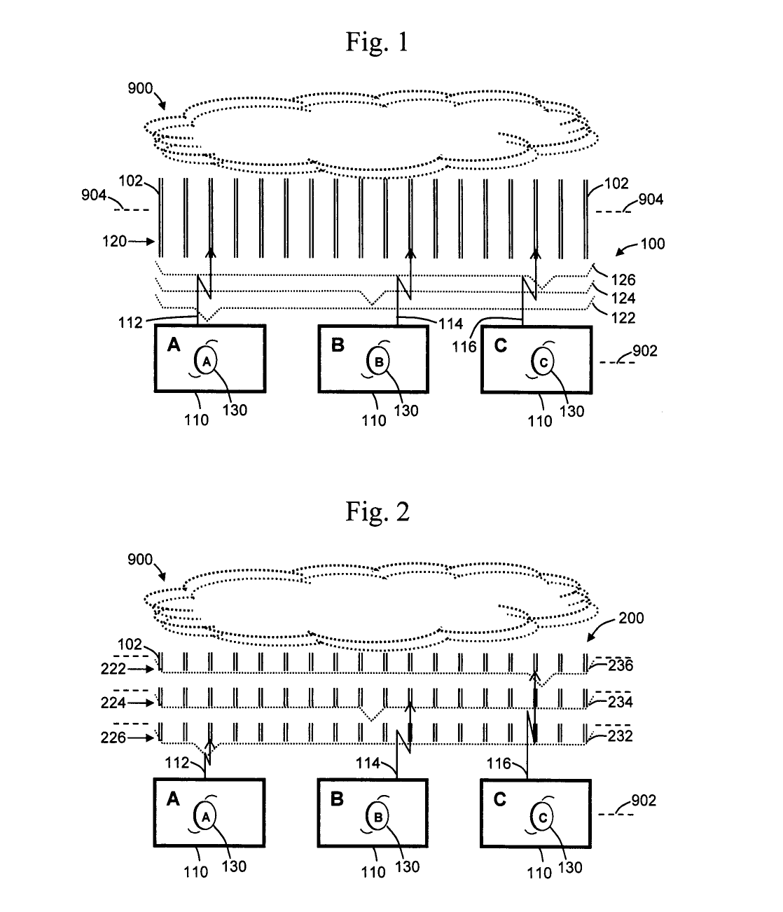

FIG. 1 schematically illustrates a system 100 for collecting messages respective to individual transactions, according to exemplary embodiments of the disclosed subject matter.

System 100 comprises a plurality of computers, indicated by three instances of a computer 110, representing any number of computes, as indicated by a dashed line 902. Each computer 110 is labeled with a letter A, B or C, and for brevity and clarity is further referenced by the respective letter label as computer-X where X stands for the letter label.

Each computer 110 has an access to a repository 120 of messages of a plurality of transactions, the messages indicated as a plurality of a message 102, representing any number of transactions and messages as indicated by dashed lines 904.

Each computer 110 has an identical or an equivalent access to repository 120, as indicated by a bracket 122, a bracket 124 and a bracket 126 for computer-A, computer-B and computer-C, respectively.

Repository 120 is provided from a monitoring process or processes or any other process or processes that track or spot or recognize messages as they originate or arrive at a node, collectively referred to a monitoring process. Generally, the monitoring process is embedded in or coupled with or linked to a multi-node transaction system 900.

Each of computer 110 executes a program or a process 130 that randomly selects one of message 102 in repository 120, as indicated by arrow an 112, an arrow 114 and an arrow 116, respective to computer-A, computer-B and computer-C. Each one of computer 110 is designed or programmed or otherwise configured to select a different message 102, such as by using different seeds of a random number generator.

It is noted that process 130 may be any mechanism that causes each of computer 110 to select one of message 102 in a seemingly random manner, where, at least to some extent, each computer 110 selects a different message 102 other than message 102 selected by any other of computer 110.

FIG. 2 schematically illustrates a system 200 for collecting messages respective to individual transactions in duplicated repositories, according to exemplary embodiments of the disclosed subject matter.

System 200 is a variant of system 100, where repository 120 is duplicated in repository 222, repository 224 and repository 226, identically or equivalently accessible by computer-A, computer-B and computer-C, respectively, as indicated by a bracket 232, a bracket 234 and a bracket 236, respectively.

Apart from the duplicated repositories, system 200 operates identically or equivalently to system 100.

It is noted that repository 120 may be duplicated to any number of duplications, typically yet not necessarily one duplication per each computer 110.

In some embodiments, the access to repository 120 and/or a duplication of repository 120 is provided by an additional construct and/or storage, such as a shared memory and/or a distributed database.

In some embodiments, a combination or a mixture of system 100 and system 200 are used, for example where some computes access a repository while other computers each accesses a duplication of the repository.

In some embodiments, a repository or a duplication thereof comprises one or more data structures in a storage medium. For example, a shared memory, or a memory accessible by via a network link, or any other apparatus capable to provide identical or equivalent access to a repository, or to a duplication thereof, by a plurality of computers.

Referring to identical or equivalent access to data by a plurality of computers implies, without limiting, access by each computer to all the data elements.

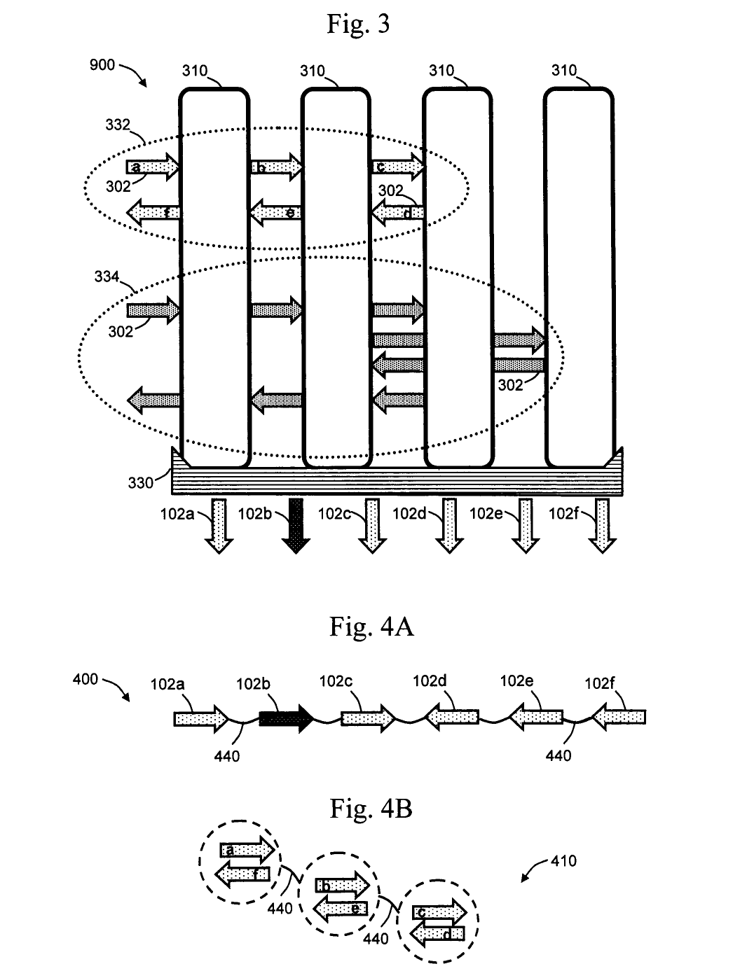

FIG. 3 schematically illustrates a multi-node transaction system 900, according to exemplary embodiments of the disclosed subject matter.

Multi-node transaction system 900 comprises a plurality of nodes indicated by four instances of a node 310, representing any number of nodes, illustrating two transactions, a transaction 332 and a transaction 334, each transaction comprising an exchange of a plurality of a communication 302 as requests and responses, where transaction 332 and transaction 334 represent any number of transactions.

The transactions are monitored by a monitoring process 330. Monitoring process 330 may be divided between the plurality of node 310 or may be shared by the plurality of node 310, or comprise any combination thereof.

Monitoring process 330 provides the messages to each of computer 110 as described above, where the provided messages comprise information on the relations of the messages to the respective transaction, for example, the ID, an indication of the source node, an indication of the destination node, a time stamp or any one or a combination thereof.

FIG. 3 further illustrate, by way of example, messages respective to the plurality of communication 302 of transaction 332 as provided by monitoring process 330. The messages denoted as 102a-102f, in correspondence to the letters labels a-f in each communication 302 of transaction 332.

For simplicity and clarity, each communication 302 is illustrated as a single communication, avoiding dividing the communication into two duplicates, one originating from a source node and one reaching a destination node.

Some non-limiting exemplary transactions are:
A request for web-sites related to a search expression is sent by a client computer to a search engine server. The search engine server further dispatches requests to storage servers according to indexing of terms in the search expression. Subsequently the storage servers respond to the search engine server with links to web-sites, where the search engine server compiles a list of sites according to the search expression and sends the list to the client computer.
Responsive to customer entries, an ATM sends a request to a bank computer for dispensing cash to the customer. The bank computer sends a query to a database computer storing the customer's account. The database computer verifies whether the customer has sufficient credit, and sends the findings to the bank computer. Subsequently, according to the credit, the bank computer sends a message to the ATM to enable or deny the cash dispensing.

FIG. 4A schematically illustrates grouping of messages denoted as 102a-102f as provided by monitoring process 330 of FIG. 3, according to exemplary embodiments of the disclosed subject matter, where each message comprises an ID respective to a transaction. As a non-limiting example, transaction 332 is referred to below.

By way of example, it is assumed that one of computer 110 randomly selected the message denoted as 102b (marked in dark shading). According to the ID comprised in the messages, the messages denoted as 102a-102f are grouped or assembled to form a representation of transaction 332. In some embodiments, the grouping is formed as a graph 400, the elements thereof connected by linking members each denoted as 440.

In some embodiments, other constructs are formed such as a hierarchical structure or any other structure. For example, FIG. 4B schematically illustrates in a graph 410 grouping of messages as request-response respective to a node, according to exemplary embodiments of the disclosed subject matter.

In some embodiments, the graph or the other constructs are formed to allow tracing of the transaction progress.

In some embodiments, once one of computer 110 finishes or decided to have finished assembly of a representation of a particular transaction, the messages of the messages of the representation are removed from the repository or a duplication thereof. Thus, each computer 110 operates independently of each other, without having to coordinate or synchronizes the respective operations thereof.

Optionally or alternatively, in some embodiments, once one of computer 110 begins assembly of a representation of a particular transaction, that computer notifies the other computers to refrain from operating on that particular transaction. Optionally, in some embodiments, that one of computer 110 notifies the other computers once assembly of the representation of that particular transaction is finished or decided to be finished, as for example, no further messages for that particular transaction were found within a certain or determined time.

For example, once assembly of a representation of transaction 332 is started, or alternatively finished or decided as finished, the computer working on the assembly of the representation of transaction 332 notifies the other computers to refrain working on the messages denoted as 102a-102f.

In some embodiments, the monitoring process gathers or groups or associates messages of a transaction so that once a message is randomly selected the other remaining messages of the transaction are readily accessible without having to scan the repository or duplication thereof for the messages of that transaction. The grouping or associations are according to, for example, the IP protocol source and/or destination, time stamps of consecutive communications, or any other method such as hashing the messages with respect to the transactions thereof.

In some embodiments, alternatively, once a message respective to a transaction is randomly selected, the other messages in repository 120 are scanned and checked whether they belong to that respective transaction. Optionally, the messages in repository 120 are sequentially selected and checked whether they belong to that respective transaction. Optionally or alternatively, the messages in repository 120 are randomly selected and checked whether they belong to that respective transaction. Optionally or alternatively, other selection regimes are used such as skipping over messages in repository 120 according to a certain or a determined or variable step. Optionally or additionally, the scanning is based on other regime, optionally comprising combination of a plurality of techniques such as described above.

In some embodiments, once a representation of a transaction is finished or decided to be finished, the messages are removed from repository 120, and optionally stored in storage where, for example, the representations of the transaction may be analyzed. Optionally or alternatively, once a representation of a transaction is finished or decided to be finished, the messages of the respective transaction are marked to the effect that the messages have been assembled. For example, the marked messages, or the representation the respective transactions may be removed from repository 120 by a process that periodically scans in or over repository 120 for candidates for removal.

In some embodiments, messages that are left over, such as determined to be outdated or superfluous, are removed from repository 120 and/or duplication thereof, or marked for subsequent disregard or removal.

Due to the random nature of selecting messages of transactions, and/or due to other factors such a incoming messages to a repository or a supplication thereof, messages of transactions may be skipped or missed or left over in the repository or a supplication thereof.

In some embodiments, an at least one additional computer such as computer 110, or one of computer 110, is configured to run a process that scans the repository or a supplication thereof and selects messages that were left over. Upon finding such messages, the process assembles representations of the respective transactions, and further handles the transactions as described above, such as removing the messages from the repository or a supplication thereof. The process, also referred to as a cleaning process, is executed in parallel to the operation of each computer 110, such as simultaneously and/or periodically or under any other regime, for example, according to the incoming traffic.

In some embodiments, the cleaning process removes messages having a time stamps so that old messages, as determined, for example, by the transactions traffic rate, are removed. Optionally or alternatively, the cleaning process is executed continuously to remove messages that were left over, such as according to a time stamp thereof or other factors such as responsive to the transactions traffic rate.

In some embodiments, a partially assembled representation of a transaction is maintained in or returned to the repository or duplication thereof, optionally by the computer that assembles the representation or by the cleaning process.

In some embodiments, a technique for selecting related data elements based on a randomly selected data element, and optionally assembly the related data elements into interrelated structures—as described above for messages of a transaction—may be generalized or expanded. For example, rather than transactions and messages thereof, other data elements having relations to an entity may be selected responsive to a randomly selected data element and, optionally, assembled to provide a representation of the respective entity. The method may be further generalized to abstract elements having relations to an abstract entity.

Furthermore, in some embodiments, the abstract entities and the abstract elements may be mapped, or applied, to definite entities and elements thereof, such as transactions and messages thereof.

For example, parts that are used to construct a product where the parts numbers relate to the product, or compounds used to prepare a certain substance where the compounds have numbers or identifications related to the substance. A relation to the product or substance is referred to, without limiting, as a part-ID.

With parts numbers as a non-limiting example for some embodiments of the present disclosure, a repository having parts numbers is provided with an access for one or more computers such as computer 110. Optionally, the repository is dynamically modified or replenished.

A part number is randomly selected by each of the one or more computers, and according to the part-ID other parts of the product are assembled to a representation of the product by way of the parts thereof, as described above for transactions and messages.

In some embodiments, a product is made up of a plurality of sub-parts or sub-assemblies, and the assembled representation of the product is provided as a graph having one or more branches and/or loops, or alternatively, as another structure such as hierarchy of the parts in the product.

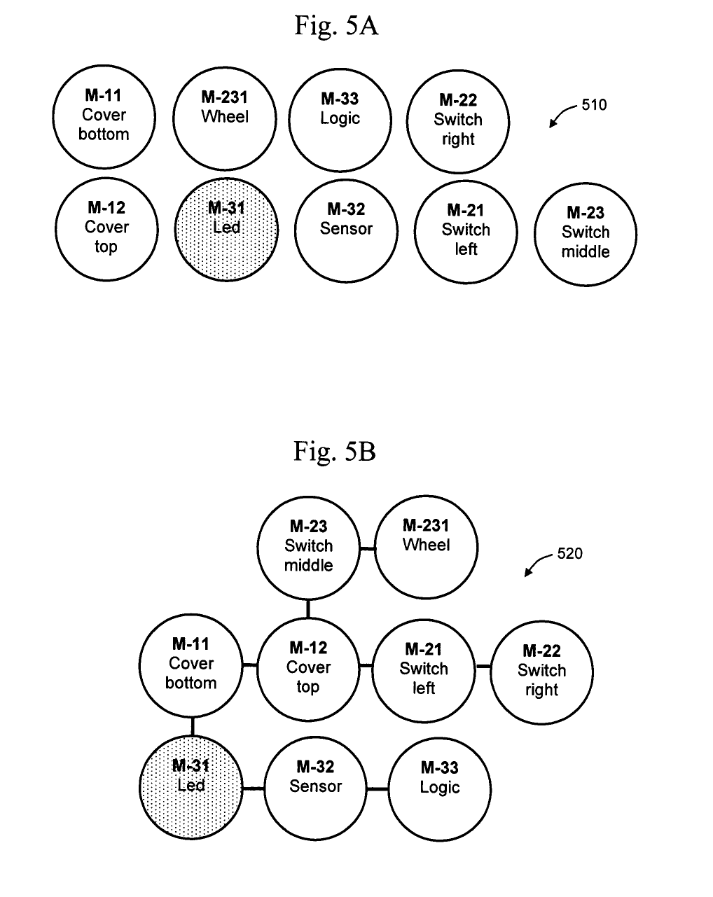

FIG. 5A schematically illustrates a repository of parts numbers of an exemplary simplified optical mouse for computers, according to exemplary embodiments of the disclosed subject matter.

The parts are related by ID formed as M-nnn where M represents the mouse and nnn represents relations between the parts. The parts are provided in a repository 510 comprising, optionally, other parts of other products.

Part of ID M-31, for example, is selected randomly, and based on the M component of the ID other parts of the mouse are assembled to represent the mouse and the relations of the parts thereof.

FIG. 5B schematically illustrates assembly of the parts numbers in repository 510 into a graph 520, according to exemplary embodiments of the disclosed subject matter.

Graph 520 illustrates exemplary simplified interrelations of the parts of the mouse as assembled based on the ID, even though the initial part was selected randomly rather than based on the hierarchy or order of the parts in the mouse.

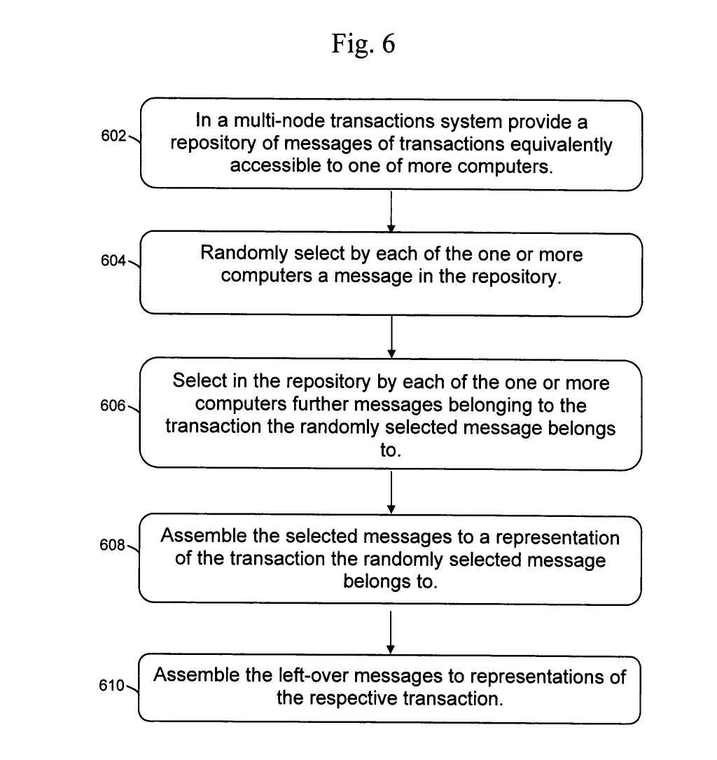

FIG. 6 outlines operations for forming or organizing a representation of transactions in a multi-node transaction system, according to exemplary embodiments of the disclosed subject matter

At 602 a repository of a plurality of messages of a plurality of transactions is provided in a multi-node transactions system, the repository equivalently accessible to one of more computers.

At 604 a message in the repository is randomly selected by each of the one or more computers, optionally independently of each other computer.

At 606 further messages, respective and/or belonging and/or related to the transaction the randomly selected message belongs and/or relates to, are selected in the repository by each of the one or more computers. The further messages are selected according to the message-ID that relates the messages to the transaction and/or according to prior grouping or association of the messages with respect to a transaction.

In some embodiments, the further messages are selected such as by serially selecting messages and checking whether they belong to the transaction the randomly selected message belongs to, or randomly selecting messages and checking whether they belong to that transaction, or by any other regime to scan or step over the messages to find the messages that belong to that transaction.

At 608 the selected messages are assembled to a representation of the transaction the randomly selected message belongs or relates to. In some embodiments, the representation of the transaction is formed as a graph or any other structure, optionally enabling to trace the transaction progress.

In some embodiments, pursuant to assembling a representation of a transaction by a computer, that computer removes the messages of the transaction from the repository.

Optionally, that computer notifies the other computers, if present, that the transaction respective to the selected message is already assembled, to the effect that the other computers, if present, would refrain from handling the same transaction.

At 610 messages that were left-over, such as due to not previously selected by the random selection, are assembled to representations of the respective transaction by a cleaning process.

In some embodiments, an additional computer and/or the one or more computers execute a cleaning process that scans the repository and assembles representations of transactions that were possibly left behind and further process the messages as described above, such as by removing the messages from the repository.

Optionally, the cleaning process cleans the repository by removing from the repository messages that are outdated such as according to a time stamp.

The cleaning process is performed continuously or according to preset or determined conditions, such as responsive to an elapsed time interval or responsive to the transactions traffic rate or a time stamp of messages.

In some embodiments, the messages are provided by a monitoring process or processes that track the communications of the transactions and optionally provide information to relate the messages to the respective transaction.

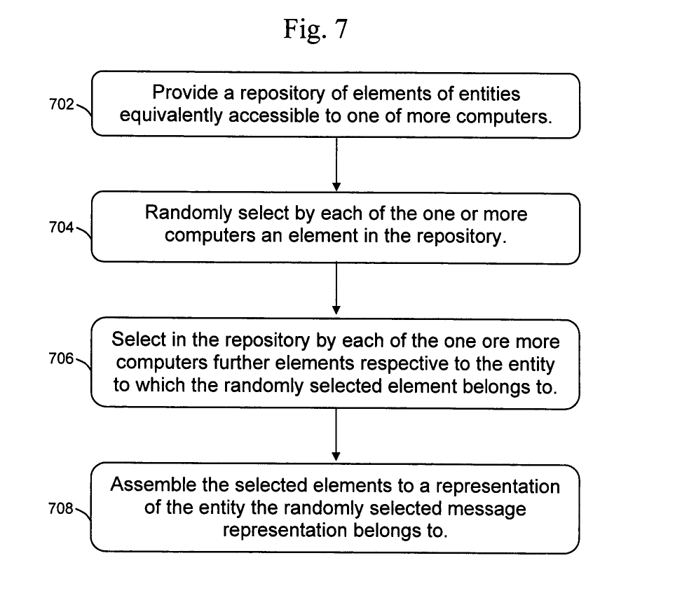

FIG. 7 outlines operation for forming a representation of an entity from elements related thereto, according to exemplary embodiments of the disclosed subject matter.

At 702 a repository of a plurality of elements of a plurality of entities is provided, the repository equivalently accessible to one of more computers.

At 704 an element in the repository is randomly selected by each of the one or more computers, optionally independently of each computer.

At 706 further elements respective and/or belonging to the entity the randomly selected element belongs to are selected in the repository by each of the one or more computers. In some embodiments, the further elements are selected according to information that relates or associates the elements to the entity.

At 708 the selected elements are assembled to a representation of the entity the randomly selected element belongs to. In some embodiments, the representation of the entity is formed as a graph or any other structure. In some embodiments, the assembly is according to indications of a hierarchy of the elements in the entity, or according to any other order of the elements with respect to the entity.

In some embodiments, elements of entities that were not assembled are scanned and optionally assembled to a representation of an entity.

There is thus provided according to the present disclosure a computerized method for organizing representations of transactions in a multi-node system, comprising randomly and independently selecting by each computer of a plurality of computers message in a repository of messages of transactions accessible to the plurality of computers, and selecting in the repository by each computer of the plurality of computers further messages belonging to the transaction the randomly selected message belongs to, and optionally assembling the selected messages to a representation of the transaction the randomly selected message belongs to.

In some embodiments, the method further comprises assembling the selected messages to a representation of the transaction the randomly selected message belongs to.

In some embodiments, the messages correspondingly comprise representations of communications of the transactions in the multi-node system.

In some embodiments, the messages comprise information relating the messages to individual transactions.

In some embodiments, the information comprises information relating to an order of the messages with respect to the transactions.

In some embodiments, the information relates to an order of the communications of the transactions in the multi-node system respective to the messages.

In some embodiments, he repository is provided by an at least one monitoring process that tracks the transactions in the multi-node system.

In some embodiments, the method further comprises removing from the repository messages of a transaction determined to be at least one of: assembled, outdated or superfluous or any combination thereof.

In some embodiments, method further comprises comprising notifying by each computer of the plurality of computers of a transaction the randomly selected message belongs to.

In some embodiments, selecting in the repository by each computer of the plurality of computers further messages is based on previously associated messages of a transaction.

In some embodiments, wherein the representation of the transaction comprises a graph or an equivalent thereof.

There is yet provided according to the present disclosure a system for organizing representations of transactions in a multi-node system, comprising a plurality of computers, each computer of the plurality of computers having equivalent access to a repository of messages of transactions and configured to randomly and independently select a message in the repository, wherein, optionally, each computer is configured for randomly selecting a different message.

In some embodiments, the system is further configured for selecting in the repository by each computer of the plurality of computers further messages belonging to the transaction the randomly selected message belongs to, and for assembling the selected messages to a representation of the transaction the randomly selected message belongs to.

In some embodiments, each computer of the plurality of computers configured to randomly select the message in the repository comprises each computer of the plurality of computers configured to randomly select a different message in the repository.

In some embodiments, configured to randomly select the different message comprises configured to execute a process configured to generate a different number for each of the plurality of computers.

There is yet provided according to the present disclosure a method for organizing elements of an entity, comprising randomly and optionally independently selecting by each computer of a plurality of computers an element in a repository of elements of entities equivalently accessible to the plurality of computers, selecting in the repository by each computer of the plurality of computers further elements belonging to the entity the randomly selected element belongs to, and optionally assembling the selected elements to a representation of the entity the randomly selected element belongs to.

In some embodiments, the method further comprises assembling the selected elements to a representation of the entity the randomly selected element belongs to.

In some embodiments, the elements comprise information relating to an order of the elements with respect to the entities.

In some embodiments, the representation of the entity comprises a graph or an equivalent thereof.

The terms ‘processor’ or ‘computer’, or system thereof, are used herein as ordinary context of the art, such as a general purpose processor or a micro-processor, RISC processor, or DSP, possibly comprising additional elements such as memory or communication ports. Optionally or additionally, the terms ‘processor’ or ‘computer’ or derivatives thereof denote an apparatus that is capable of carrying out a provided or an incorporated program and/or is capable to controlling and/or accessing data storage apparatus and/or other apparatus such as input and output ports. The terms ‘processor’ or ‘computer’ denote also a plurality of processors or computers connected, and/or linked and/or otherwise communicating, possibly sharing one or more other resources such as a memory.

The terms ‘software’, ‘program’, ‘software procedure’ or ‘procedure’ or ‘software code’ or ‘code’ may be used interchangeably according to the context thereof, and denote one or more instructions or directives or circuitry for performing a sequence of operations that generally represent an algorithm and/or other process or method. The program is stored in or on a medium such as RAM, ROM, or disk, or embedded in a circuitry accessible and executable by an apparatus such as a processor or other circuitry.

The processor and program may constitute the same apparatus, at least partially, such as an array of electronic gates, such as FPGA or ASIC, designed to perform a programmed sequence of operations, optionally comprising or linked with a processor or other circuitry.

The term computerized apparatus or a similar one denotes an apparatus having one or more processors operable or operating according to a program.

The term configuring for a objective or a variation thereof implies using a software and/or electronic circuit designed and/or operable or operative to achieve the objective.

The processor and/or program stored in or on a device constitute an article of manufacture.

The flowchart and block diagrams illustrate an architecture, a functionality or an operation of possible implementations of systems, methods and computer program products according to various embodiments of the present disclosed subject matter. In this regard, each block in the flowchart or block diagrams may represent a module, segment, or portion of program code, which comprises one or more executable instructions for implementing the specified logical function(s). It should also be noted that, in some alternative implementations, illustrated operations may occur in deferent order or as concurrent operations instead of sequential operations to achieve the same or equivalent effect.

The corresponding structures, materials, acts, and equivalents of all means or step plus function elements in the claims below are intended to include any structure, material, or act for performing the function in combination with other claimed elements as specifically claimed. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The terminology used herein is for the purpose of describing particular embodiments only and is not intended to be limiting of the disclosed subject matter. While certain embodiments of the disclosed subject matter have been illustrated and described, it will be clear that the invention is not limited to the embodiments described herein. Numerous modifications, changes, variations, substitutions and equivalents are not precluded.

1. A computerized method for organizing representations of transactions in a multi-node system, comprising:
in a repository of messages of transactions, the repository equivalently accessible to a plurality of computers, randomly selecting a message by each computer of the plurality of computers independently of each other computer; and
selecting in the repository by each computer of the plurality of computers further messages belonging to the transaction the randomly selected message belongs to.

2. The computerized method for organizing representations of transactions in a multi-node system according to claim 1, further comprising assembling the selected messages to a representation of the transaction the randomly selected message belongs to.

3. The computerized method for organizing representations of transactions in a multi-node system according to claim 1, wherein the messages correspondingly comprise representations of communications of the transactions in the multi-node system.

4. The computerized method for organizing representations of transactions in a multi-node system according to claim 1, wherein the messages comprise information relating the messages to individual transactions.

5. The computerized method for organizing representations of transactions in a multi-node system according to claim 4, wherein the information comprises information relating to an order of the messages with respect to the transactions.

6. The computerized method for organizing representations of transactions in a multi-node system according to claim 4, wherein the information relates to an order of the communications of the transactions in the multi-node system respective to the messages.

7. The computerized method for organizing representations of transactions in a multi-node system according to claim 1, wherein the repository is provided by an at least one monitoring process that tracks the transactions in the multi-node system.

8. The computerized method for organizing representations of transactions in a multi-node system according to claim 1, further comprising removing from the repository messages of a transaction determined to be at least one of: assembled, outdated or superfluous or any combination thereof.

9. The computerized method for organizing representations of transactions in a multi-node system according to claim 1, further comprising notifying by each computer of the plurality of computers of a transaction the randomly selected message belongs to.

10. The computerized method for organizing representations of transactions in a multi-node system according to claim 1, wherein selecting in the repository by each computer of the plurality of computers further messages is based on previously associated messages of a transaction.

11. The computerized method for organizing representations of transactions in a multi-node system according to claim 2, wherein the representation of the transaction comprises a graph or an equivalent thereof.

12. A computerized system for organizing representations of transactions in a multi-node system, comprising:
a plurality of computers, each computer of the plurality of computers having equivalent access to a repository of messages of transactions and configured to randomly select a message in the repository independently of each other computer.

13. The computerized system for organizing representations of transactions in a multi-node system according to claim 12, further configured for selecting in the repository by each computer of the plurality of computers further messages belonging to the transaction the randomly selected message belongs to, and for assembling the selected messages to a representation of the transaction the randomly selected message belongs to.

14. The computerized system for organizing representations of transactions in a multi-node system according to claim 12, wherein each computer of the plurality of computers configured to randomly select the message in the repository comprises each computer of the plurality of computers configured to randomly select a different message in the repository.

15. The computerized system for organizing representations of transactions in a multi-node system according to claim 14, wherein configured to randomly select the different message comprises configured to execute a process configured to generate a different number for each of the plurality of computers.

16. A method for organizing elements of an entity, comprising:
in a repository of elements of entities, the repository equivalently accessible to a plurality of computers, randomly selecting an element by each computer of the plurality of computers independently of each other computer; and
selecting in the repository by each computer of the plurality of computers further elements belonging to the entity the randomly selected element belongs to.

17. The method for organizing elements of an entity according to claim 16, further comprising assembling the selected elements to a representation of the entity the randomly selected element belongs to.

18. The method for organizing elements of an entity according to claim 16, wherein the elements comprise information relating to an order of the elements with respect to the entities.

19. The method for organizing elements of an entity according to claim 17, wherein the representation of the entity comprises a graph or an equivalent thereof.
